(19) United States
(12) Patent Application Publication
(10) Pub. No.: US 2002/0066108 A1
(43) Pub. Date: May 30, 2002

(54) Image data transfer system

(75) Inventor: Masashi Aonuma, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: Fuji Photo Film Co., Ltd.

(21) Appl. No.: 09/989,161

(22) Filed: Nov. 21, 2001

(30) Foreign Application Priority Data
Nov. 24, 2000 (JP) 358218/2000

(51) Int. Cl. G06F 3/00; H04N 7/173

(52) U.S. Cl. 725/94; 725/115

(57) ABSTRACT

Image data read by an image information reading apparatus can be securely transferred to an image display apparatus connected thereto by a network, while a user does not feel stressed due to waiting for image confirmation. The image information reading apparatus comprises a buffer memory for storing the image data for one sheet, and the image data read by a reading unit of the reading apparatus are sequentially stored in the buffer memory while sequentially transferred to the image display apparatus via the network. The image display apparatus sequentially displays on a monitor the image data transferred thereto as a visible image.

### BACKGROUND OF THE INVENTION

1. Field of the Invention

The present invention relates to an image data transfer system for transferring image data from an image information reading apparatus to an image display apparatus connected to the image information reading apparatus via a network.

2. Description of the Related Art

Radiation image information reading apparatuses for reading radiation image information from stimulable phosphor sheets having radiation image information recorded therein have been known (see Japanese Unexamined Patent Publication No. 62(1987)-18536, for example). In a radiation image information reading apparatus, an excitation light such as a laser beam is irradiated on a stimulable phosphor sheet having radiation image information recorded therein (hereinafter referred to as the sheet), and a phosphorescent light emitted from the sheet in accordance with the radiation image information stored in the sheet is detected to obtain the radiation image information. In the radiation image information reading apparatus, a laser beam is irradiated on an entire surface of the sheet by light beam scanning means for example, and the phosphorescent light emitted from the sheet is led to reading means comprising a photoelectric conversion device such as a photomultiplier via a light guide, and an electric signal (an image signal) is obtained by photoelectric conversion of the phosphorescent light. Image data (the image signal) obtained by the radiation image information reading apparatus are subjected to appropriate image processing and used for diagnosis. At the time of reading, the image data are displayed as a visible image on display means such as a monitor for confirmation of whether or not an image represented by the image data was appropriately photographed. Conventionally, images are confirmed while being displayed sequentially on a monitor attached to the radiation image information reading apparatus at the time reading. After confirmation, the image data are subjected to the image processing such as tone processing and frequency processing by the radiation image information reading apparatus, and output to an image processing apparatus for carrying out further image processing, or to an image recording apparatus, or to an external output apparatus such as a printer.

For the sake of downsizing and cost reduction, a system for carrying out image confirmation, image processing and the like by using a general-purpose computer has been proposed. For example, if an image is confirmed on a monitor of a general-purpose computer, the radiation image information reading apparatus does not need to have a monitor. In this manner, the radiation image information reading apparatus can become smaller and less expensive.

In the case where the radiation image information reading apparatus and the image display apparatus for image confirmation are in separate housings as in the above example, the image data are exchanged between the two apparatuses via a network. In this case, the radiation image information reading apparatus and the image display apparatus are connected by the network using Ethernet, USB, or IEEE 1394, for example. The image data are transferred from the radiation image information reading apparatus to the image display apparatus via the network. However, a transfer speed for the image data changes, depending on how other apparatuses connected to the network are used. In the case where the image is read by scanning with a laser beam as in the above example, an image reading speed is constant. Therefore, when the image data read by the apparatus are sequentially output to the network, a portion of the image data may be lost if the transfer speed of the network is slower than the reading speed. For this reason, when the image data read by the radiation image information reading apparatus are transferred to the image display apparatus, the image data for one image may be read and stored in a memory and transferred thereafter, in order not to be affected by the change in the transfer speed.

However, in this case, the image data are not transferred to the image display apparatus to be displayed thereon unless the image data for one image have been completely read. Therefore, a user feels that he/she has been waiting long.

### SUMMARY OF THE INVENTION

The present invention has been conceived based on consideration of the above problem. An object of the present invention is therefore to provide an image data transfer system for enabling secure transfer of image data read by an image information reading apparatus to an image display apparatus connected to the image information reading apparatus by a network, and for enabling reduction of stress of a user caused by waiting for image confirmation.

An image data transfer system of the present invention comprises an image information reading apparatus for reading image data representing an image from a sheet having the image recorded therein and an image display apparatus to which the image data read by the reading apparatus are transferred. The image display apparatus is connected to the image information reading apparatus by a network and displays the image data as a visible image. The image data transfer system of the present invention is characterized by the image information reading apparatus comprising a buffer memory for storing the image data of the sheet and sequentially stores in the buffer memory the image data obtained at the time of reading the image data while sequentially outputting the image data stored in the buffer memory.

In other words, in the image data transfer system of the present invention, the image is read by the image information reading apparatus while being displayed on the image display apparatus. The image data stored in the buffer memory are ready to be output, and the image data are transferred from the buffer memory to the image display apparatus at an output speed in accordance with a transfer speed on the network.

Although the image data are sequentially output from the buffer memory, it is preferable for the image data to be stored in the buffer memory until the image data have been read for at least one sheet.

According to the image data transfer system of the present invention, the image information reading apparatus has the buffer memory for storing the image data for one sheet. The image data read by the reading apparatus are sequentially stored in the buffer memory, and the image data stored in the memory are sequentially transferred to the image display apparatus. Therefore, the image display apparatus can display a visible image represented by the image data while the image is being read by the image information reading apparatus. In this manner, a user does not feel stressed due to waiting for image display.

Since the image data are temporarily stored in the buffer memory and sequentially output therefrom, the image data can be output in accordance with a change in the transfer speed on the network. Therefore, the image data are not lost.

Furthermore, since the buffer memory for storing the image data for one sheet is used, the image data can be output while the image data are being stored for one sheet. Therefore, even in the case where the image data are not correctly transferred to the image display apparatus due to a communication problem, the image data stored in the buffer memory can be retransferred to the image display apparatus. In this manner, the image display apparatus can obtain the correct image data.

### BRIEF DESCRIPTION OF THE DRAWINGS

FIG. 1 is a diagram showing an embodiment of an image data transfer system of the present invention;

FIG. 2 is shows the outward appearances of an image information reading apparatus and an image display apparatus of the embodiment;

FIG. 3 is a cross-sectional view showing a configuration of the image information reading apparatus in the embodiment;

FIG. 4 is a cross-sectional enlargement of a reading unit in the image information reading apparatus shown in FIG. 3; and

FIG. 5 is a perspective view showing a configuration of the reading unit in the image information reading apparatus.

### DESCRIPTION OF THE PREFERRED EMBODIMENT

Hereinafter, an embodiment of the present invention will be explained with reference to the accompanying drawings.

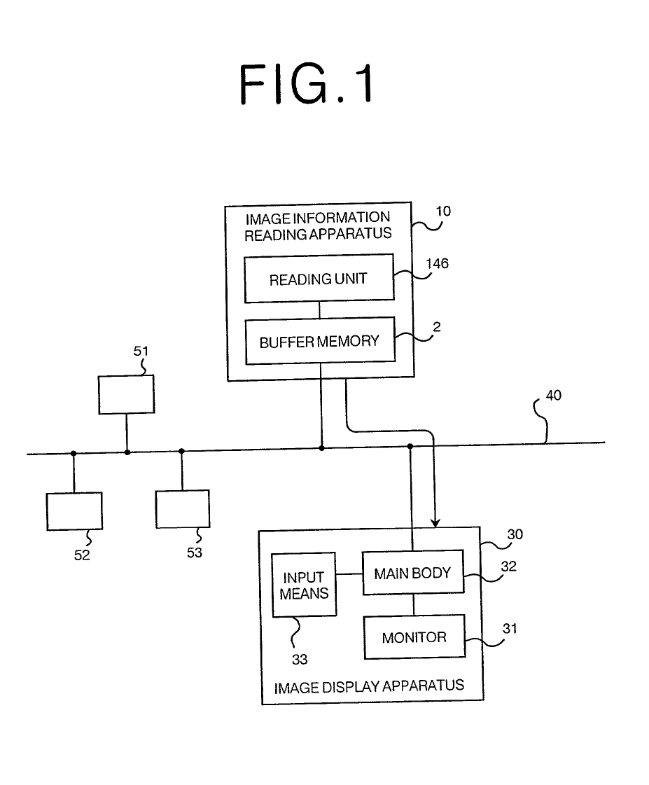

FIG. 1 is a diagram showing a configuration of an embodiment of an image data transfer system of the present invention. The image data transfer system of the present invention transfers image data between an image information reading apparatus 10 and an image display apparatus 30 via a network 40. Other apparatuses such as an image processing apparatus 51, an image recording apparatus 52, and an image output apparatus 52 are also connected to the network 40.

The image information reading apparatus 10 comprises a reading unit 146 and a buffer memory 2. The reading unit 146 scans a stimulable phosphor sheet having a radiation image recorded therein with an excitation light, and receives a phosphorescent light emitted from the sheet. The phosphorescent light is photoelectrically converted in the reading unit 146 and the image data are obtained therein. The buffer memory 2 has a capacity for storing the image data for at least one sheet.

The image data are transferred from the image information reading apparatus 10 to the image display apparatus 30, and the image display apparatus 30 displays a visible image represented by the image data. The image display apparatus 30 comprises a monitor 31 for displaying the image data as the visible image, a main unit 32, and input means 33 comprising a keyboard and a mouse. The main unit 32 comprises an image storing unit for storing the image data transferred from the image information reading apparatus 10, a processing unit for carrying out processing on the image data, and a control unit for controlling image display on the monitor 31 and for controlling output of the image data, for example.

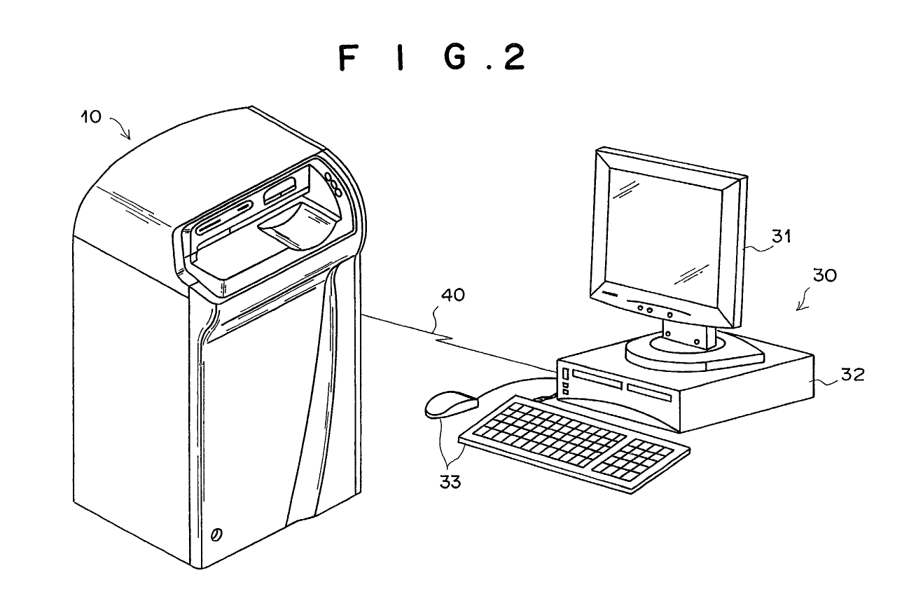

FIG. 2 shows the outward appearances of the image information reading apparatus 10 and the image display apparatus 30. A general-purpose personal computer or a workstation can be used as the image display apparatus 30, and a personal computer comprising a liquid crystal display monitor is shown in FIG. 2 as an example of the image display apparatus 30. The personal computer 30 and the image information reading apparatus 10 are connected via the network 40.

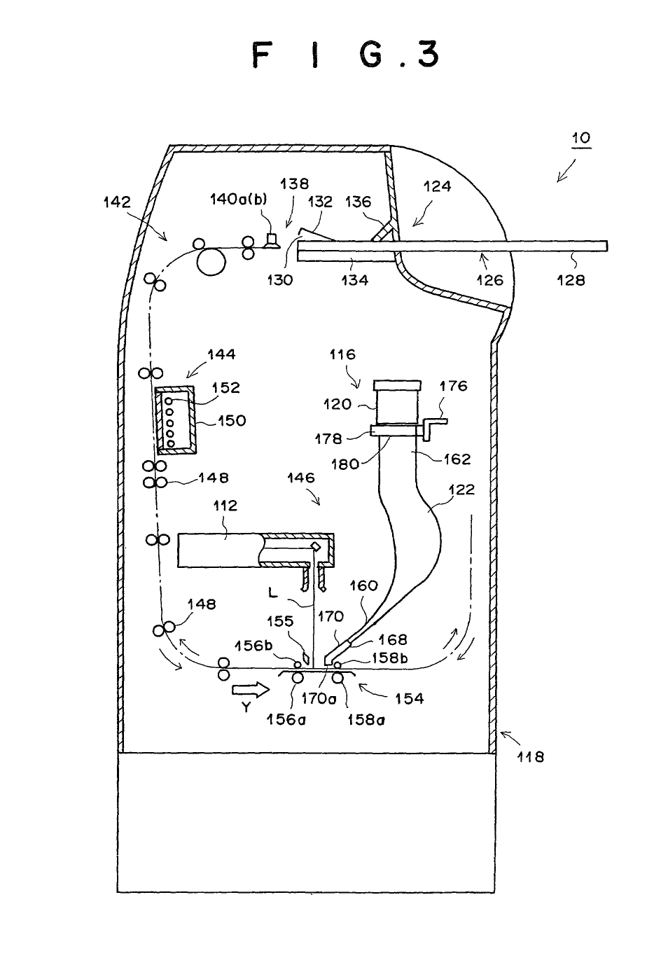

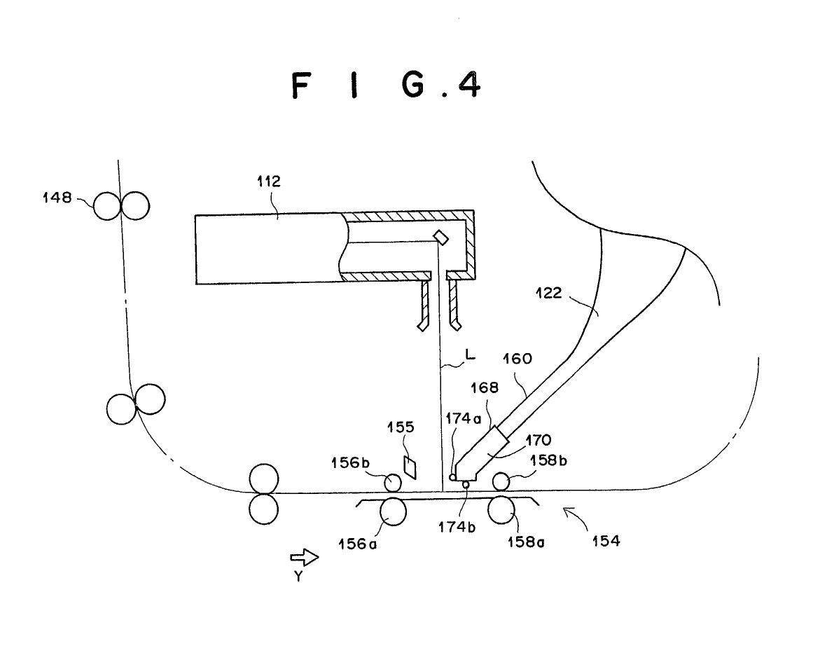

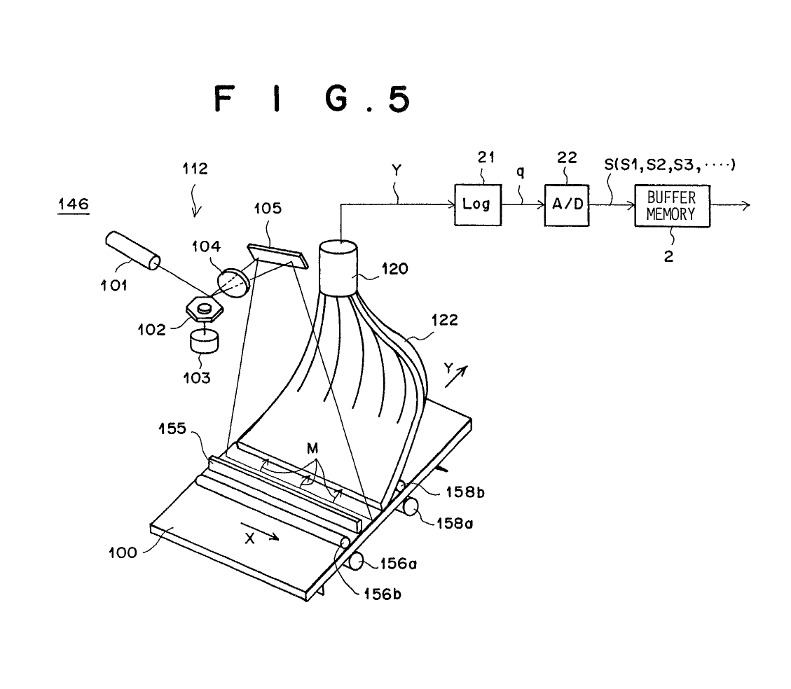

Hereinafter, a configuration and operation of the image information reading apparatus 10 will be explained with reference to FIGS. 3 to 5. FIG. 3 is a cross-sectional view showing a configuration of the image information reading apparatus 10 shown in FIG. 2, and FIG. 4 is a cross-sectional enlargement of the reading unit of the image information reading apparatus 10 shown in FIG. 3. FIG. 5 is a perspective view showing a configuration of the reading unit of the image information reading apparatus 10 shown in FIG. 3.

The image information reading apparatus 10 shown in FIG. 3 comprises a main body 118 having therein a cassette loading unit 124 for loading and unloading a cassette storing a stimulable phosphor sheet 100 set therein, a reading unit 146 for photoelectrically reading the radiation image by irradiating a laser beam L as an excitation light on the stimulable phosphor sheet 100 having the radiation image recorded therein, an erasing unit 144 for erasing the radiation image remaining in the sheet after reading the radiation image, and a conveyance system 142 for conveying the sheet 100 along a predetermined path passing the reading unit 146 and the erasing unit 144.

The cassette loading unit 124 is located in an upper front (an operation panel) of the main body 118. A supporting table 134 for placing the cassette 126 thereon is located at an opening of the cassette loading unit 124. A shutter 136 which opens and closes freely is also placed at the opening for preventing light from entering the main body 118. A sheet insertion/ejection unit 138 for taking out the sheet 100 from the cassette 126 and returning to the cassette 126 the sheet 100 after reading and erasing processing that will be explained later are located inside the cassette loading unit 124. The cassette 126 has a casing box 128 and a lid 132 which opens and closes freely at an opening 130 of the casing box 128. The stimulable phosphor sheet 100 is stored in the casing box 128. The sheet insertion/ejection unit 138 comprises suction cups 140a and 140b which can freely enter or exit from the cassette 126 whose lid 132 is open in the cassette loading unit 124 for storing or ejecting the sheet 100.

The conveyance system 142 comprises pairs of rollers 148. The erasing unit 144 is located on a path of vertical conveyance along the roller pairs 148, and the reading unit 146 is located on a path of horizontal conveyance comprising the pairs of rollers 148.

The erasing unit 144 has an erasing component 150 located on an image recording side of the sheet 100. The erasing component 150 has inside a plurality of erasing light sources 152 placed vertically.

The reading unit 146 comprises a vertical scanning conveyance mechanism 154 for conveying the sheet 100 in a vertical scan direction (a direction shown by an arrow Y) laser beam irradiation means 112 for irradiating the laser beam L on the sheet 100 in a main scan direction (a direction orthogonal to the vertical scan direction) while the sheet 100 is conveyed in the vertical scan direction, light detection means 116 for photoelectrically reading the phosphorescent light emitted from the sheet 100 upon exposure to the laser beam L, and a reflection mirror 155 for efficiently leading the phosphorescent light to the light detection means 116.

The vertical scanning conveyance mechanism 154 comprises first and second pairs of rollers 156 and 158 driven in synchronization. The first and second pairs of rollers 156 and 158 comprise driving rollers 156a and 158a, and nip rollers 156b and 158b that engage and disengage freely with the driving rollers 156a and 158a.

The light detection means 116 comprises a photomultiplier 120 as photoelectric conversion means and a light collection guide 122 attached at the bottom of the photomultiplier 120. The light collection guide 122 is made of a material that allows a light to pass through, such as an acrylic resin. An end of the guide from which the phosphorescent light enters is located close to a laser beam irradiation position and has a flat shape. Another end of the guide from which the phosphorescent light emerges has a plurality of slots in the material and is bent toward the photomultiplier 120 to converge on a small cylinder-like shape. The photomultiplier 120 is located at a convergent end 162 having the cylindrical shape, via an excitation light cutoff filter.

A flat-shape end 160 of the guide 122 is located close to the position at which the laser beam L is irradiated, and the phosphorescent light emitted from the image recording side of the sheet 100 is collected by the guide 122. The phosphorescent light is then led to the photomultiplier 120 and photoelectrically converted to be output as an electric signal.

The convergent end 162 of the light guide 122 passes through a through hole 180 of a holding component 178 fixed to a frame 176 of the main body 118 of the reading apparatus 10. The photomultiplier 120 is attached to an upper portion of the convergent end 162 that passes through the hole 180. The flat-shaped end 160 of the light guide 122 has a bracket 168 screwed thereto. Both ends of the bracket 160 have a fixing component 170 screwed thereto in a lengthwise direction thereof. A bottom surface of a hook 170a of the fixing component 170 is attached to a frame 174a of the main body 118. Meanwhile, a side of the hook 170a is fixed to a frame 174b. In other words, the light detection means 116 is supported in three directions by the frames 174a, 174b, and 176.

As shown in FIG. 5, the laser beam irradiation means 112 comprises a laser beam source 101 for emitting the laser beam L, a rotating polygon mirror 102 for reflecting and deflecting the laser beam L, a motor 103 for driving the mirror 102 in a direction shown by an arrow Z at a high speed, a light focusing lens 104 such as an fθ lens for focusing the beam L on the stimulable phosphor sheet 100, and a mirror 105 for reflecting the excitation light that has passed through the lens 104 toward the sheet 100.

Operation of the image information reading apparatus 10 will be explained below.

The cassette 126 storing the stimulable phosphor sheet 100 having image information for a subject such as a human body recorded therein by a photographing apparatus (not shown) is set in the cassette loading unit 124 of the image information reading apparatus 10. The sheet 100 is led to a predetermined position inside the casing main body 118 along the supporting table 134 located at the opening of the cassette loading unit 124. At this time, the cassette 126 presses and opens the shutter 136, and the lid 132 is moved to a predetermined position.

The suction cups 140a and 140b of the sheet insertion/ejection unit 138 move down to a base surface of the sheet 100 in the cassette 126 while not interfering with the lid 132, and adhere to the base surface of the sheet 100. The suction cups 140a and 140b move in this state from a side of the cassette 126 toward the conveyance system 142, and a front end of the sheet 100 is sandwiched by one of the pairs of rollers 148.

The sheet 100 is conveyed from a horizontal direction to a vertical direction by rotation of the pairs of rollers 148 of the conveyance system 142, and passes the erasing unit 144. Thereafter, the sheet 100 is conveyed to the reading unit 146 while being conveyed horizontally.

In the reading unit 146, the sheet 100 is conveyed while being vertically scanned in the direction of the arrow Y by the first and second roller pairs 156 and 158 of the vertical scanning conveyance mechanism 154. Meanwhile, the laser beam L emitted from the laser beam source 101 is reflected and deflected by the rotating polygon mirror 102 driven by the motor 103 in the direction of the arrow Z. The deflected laser beam L passes the light focusing lens 104 such as the fθ lens and changes a path thereof due to the mirror 105. The laser beam L then reaches the sheet 100 and main-scans the sheet 100 in a direction shown by an arrow X orthogonal to the direction of sheet conveyance (the direction shown by the arrow Y). In this manner, the sheet 100 is two-dimensionally scanned with the laser beam L over an entire surface thereof, during the vertical scan conveyance and the main scan.

A phosphorescent light M is emitted in accordance with an amount of the radiation image information recorded in a portion of the sheet on which the laser beam L was irradiated. The phosphorescent light M is led by the light collection guide 122 and photoelectrically detected by the photomultiplier 120. In detail, the phosphorescent light M is directly led by the light collection guide 122 or reflected by the reflection mirror 155 toward the light collection guide 122. The phosphorescent light M reaches the photomultiplier 120 along the guide 122, and photoelectric conversion is carried out therein. The phosphorescent light is converted into the electric signal and output to an external circuit.

The sheet 100 after reading is returned by switchback of the vertical scanning conveyance mechanism 154, and conveyed in the vertical direction toward the sheet insertion/ejection unit 138 after passing the erasing component 150 of the erasing unit 144. At this time, the erasing light is irradiated on the image recording side of the sheet 100 from the erasing light sources 152 of the erasing component 150. In this manner, the radiation image information remaining in the sheet 100 is erased. The sheet 100 after this erasing processing is stored in the cassette 126 by the suction cups 140a and 140b of the sheet insertion/ejection unit 138, and the operation ends.

The sheet 100 after the erasing processing can record another image therein.

An analog signal y output from the photomultiplier 120 is logarithmically amplified by a logarithmic amplifier 21 and converted into a logarithmic image signal q. The logarithmic image signal q is input to an A/D conversion circuit 22 and converted into digital image data s by being sampled at a predetermined sampling period T.

The image data s (s1, s2, s3, . . . ) are sequentially obtained by the scan with the laser beam L and the image data are sequentially stored in the buffer memory 2.

The image data S stored in the buffer memory 2 are transferred to the image display apparatus 30 via the network 40 in order of storage (s1, s2, s3, . . . ). The image display apparatus 30 sequentially displays the image data s transferred thereto as the visible image on the monitor 31. Therefore, the image is displayed on the monitor 31 of the image display apparatus 30 while image reading is being carried out in the image information reading apparatus 10.

For the network 40, Ethernet, USB, or IEEE1394 may be used, for example. The image processing apparatus 51, the image recording apparatus 52, and the image output apparatus 53 are also connected to the network 40, and a transfer speed for the image data from the image information reading apparatus 10 to the image display apparatus 30 can change depending on how the network 40 is being used. An output speed for the image data from the buffer memory 2 of the image information reading apparatus 10 also depends on the transfer speed of the network 40. If the image information reading apparatus 10 sequentially outputs the image data to the image display apparatus 30 without storing the image data in the buffer memory 2, the image data may be lost in the case where the transfer speed on the network 40 is slower than an image reading speed, since the image reading speed is constant. However, in the system of the present invention described above, the image data are temporarily stored in the buffer memory 2 and the output speed from the memory 2 can be changed appropriately. Therefore, loss of the image data can be avoided. Furthermore, even in the case of a communication problem, the image data for one image are stored in the buffer memory 2. Therefore, the image display apparatus 30 can receive the correct image data after the image data are retransferred thereto.

The image information reading apparatus 10 stores the image data in a storing unit thereof when the image data are transferred from the image display apparatus 30. Therefore, after a user confirms the image on the monitor 31, the image data are processed and output as an image on a film, for example, according to an instruction from the user input at the keyboard 33.

In the above embodiment, the stimulable phosphor sheet is used as the sheet to record the image. However, the present invention is not limited to the above example, and any sheet on which an image is or can be recorded can be used.

What is claimed is:

1. An image data transfer system comprising an image information reading apparatus for reading image data representing an image from a sheet having the image recorded therein and an image display apparatus connected to the image information reading apparatus by a network, the image data read by the image information reading apparatus being transferred to the image display apparatus and the image display apparatus displaying the image data as a visible image, wherein
the image information reading apparatus comprises a buffer memory for storing the image data for the sheet and sequentially stores in the buffer memory the image data obtained at the time of reading the image data while sequentially outputting the image data from the buffer memory.
